(19) United States
(12) Patent Application Publication
(10) Pub. No.: US 2022/0198261 A1
(43) Pub. Date: Jun. 23, 2022

(54) ARTIFICIAL INTELLIGENCE VIA HARDWARE-ASSISTED TOURNAMENT

(71) Applicant: Advanced Micro Devices, Inc., Santa Clara, CA (US)

(72) Inventors: Sergey Blagodurov, Bellevue, WA (US); Yasuko Eckert, Bellevue, WA (US); John D. Wilkes, Bellevue, WA (US)

(73) Assignee: Advanced Micro Devices, Inc., Santa Clara, CA (US)

(21) Appl. No.: 17/131,546

(22) Filed: Dec. 22, 2020

(51) Int. Cl. G06N 3/08; G06N 3/04

(52) U.S. Cl. CPC G06N 3/08; G06N 3/04

(57) ABSTRACT

A system and method for providing for adoption of solvers for solving at least one task is disclosed. The system and method include a controller, solvers capable of solving the at least one task, and at least one memory. The controller admits ones of the solvers into a competition for solving the at least one task, provides, via the at least one memory, an input of the task to the admitted solvers, provides, via the at least one memory, intermediate results of execution by the admitted solvers that are provided the input, receives a prediction of the next intermediate result from the admitted solvers predicting from at least one of the provided input and received intermediate results, and ranks the at least one of the admitted solvers for solving the task based on at least one of the next intermediate results, the provided input and received intermediate results.

### BACKGROUND

Artificial Intelligence (AI) is widely believed to be the next major shift in how the computing systems solve problems. From datacenter operators to High Performance Computing (HPC) domain users, users are hoping for efficient AI solutions for their tasks. The key challenge with adopting AI, and other solutions, is whether the novel algorithmic breakthroughs like Neural Networks consistently outperform the incumbent algorithms on the exact problem and input at hand, rather than in an abstract sense. All around, clients are weighing in on whether AI can solve their tasks better than the incumbent algorithms from traditional ML and domain-specific literature, like Monte-Carlo analysis. To be able to widely adopt AI, a system and method is needed to reliably compare different solvers because a system that does not take advantage of the mechanism on-the-fly will result in inferior performance and/or energy waste, as inferior solvers may be instead employed.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more features of the disclosure can be implemented;

FIG. 2 is a block diagram of the device of FIG. 1, illustrating additional detail;

FIG. 3 is a block diagram illustrating a graphics processing pipeline, according to an example;

FIG. 4 illustrates a graphical depiction of an artificial intelligence system incorporating the example device of FIG. 1;

FIG. 5 illustrates a method performed in the artificial intelligence system of FIG. 4;

FIG. 6 illustrates an example of the probabilities of a naive Bayes calculation;

FIG. 7 illustrates an exemplary decision tree;

FIG. 8 illustrates an exemplary random forest classifier;

FIG. 9 illustrates an exemplary logistic regression;

FIG. 10 illustrates an exemplary support vector machine;

FIG. 11 illustrated an exemplary linear regression model;

FIG. 12 illustrates an exemplary K-means clustering;

FIG. 13 illustrates an exemplary ensemble learning algorithm;

FIG. 14 illustrates an exemplary neural network;

FIG. 15 illustrates a hardware diagram of a system to provide hardware assisted tournament for AI adoption; and

FIG. 16 illustrates a method performed in the hardware of FIG. 15 for providing hardware assisted tournament for AI adoption.

### DETAILED DESCRIPTION

The present system and method include ways of making sure the artificial intelligence (AI) techniques perform as expected, or advertised, to reliably outperform the incumbents. The present system and method compare the solvers with each other without cumbersome involvement from the user or the operator to rerun the same experiments with multiple algorithms.

The present system and method provide a framework to allow the solvers to compete in a tournament for the right of solving the specific task in the future. The system and method include a controller, referred to also as a tournament controller, in the form of an application-specific integrated circuit (ASIC) circuit able to admit and employ one or more algorithmic solvers (e.g., AI and incumbent) for a specific task to compete with each other on-the-fly for the right of solving the given computational problem in the future. This system and method identify the most efficient way of solving a given task by gradual adoption of a new solver.

A system and method for providing a hardware assisted tournament for adoption of one of a plurality of solvers for solving at least one task is disclosed. The system and method include a controller including at least one processor, a plurality of solvers capable of solving the at least one task, and at least one memory. The controller via the at least one processor is configured to admit ones of the plurality of solvers into a competition for solving the at least one task, provide, via the at least one memory, an input of the at least one task to at least one of the admitted ones of the plurality of solvers, provide, via the at least one memory, intermediate results of execution by the at least one of the admitted ones of the plurality of solvers that are provided the input, receive a prediction of the next intermediate result from the at least one of the admitted ones of the plurality of solvers predicting from at least one of the provided input and received intermediate results, and rank the at least one of the admitted ones of the plurality of solvers for solving the task based on at least one of the next intermediate results, the provided input and received intermediate results. The controller may designate a selected solver based on the ranking of the at least one of the admitted ones of the plurality of solvers. The controller may use the designated solver for future processing of the task. The plurality of solvers may include at least one domain-specific solver, including at least one of a Monte Carlo, Particle Methods, and Sparse Solver, at least one traditional machine learning (ML) solver, including at least one of a Markov, Decision trees, and support vector machine (SVM) solver, and at least one artificial intelligence (AI) solver, including at least one of a Convolutional and long short-term memory (LSTM) Neural Networks solver.

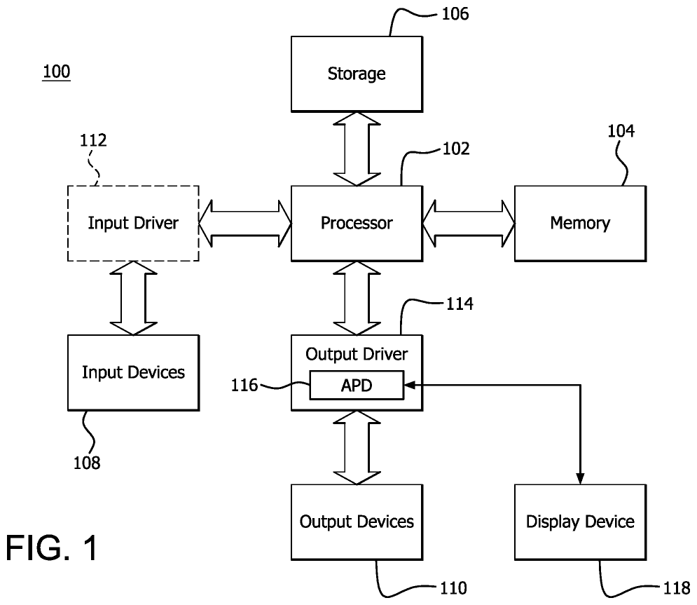

FIG. 1 is a block diagram of an example device 100 in which one or more features of the disclosure can be implemented. The device 100 can include, for example, a computer, a gaming device, a handheld device, a set-top box, a television, a mobile phone, or a tablet computer. The device 100 includes a processor 102, a memory 104, a storage 106, one or more input devices 108, and one or more output devices 110. The device 100 can also optionally include an input driver 112 and an output driver 114. It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, a hard disk drive, a solid-state drive, an optical disk, or a flash drive. The input devices 108 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. It is noted that the input driver 112 and the output driver 114 are optional components, and that the device 100 will operate in the same manner if the input driver 112 and the output driver 114 are not present. The output driver 114 includes an accelerated processing device (“APD”) 116 which is coupled to a display device 118. The APD accepts compute commands and graphics rendering commands from processor 102, processes those compute and graphics rendering commands, and provides pixel output to display device 118 for display. As described in further detail below, the APD 116 includes one or more parallel processing units to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and provides graphical output to a display device 118. For example, it is contemplated that any processing system that performs processing tasks in accordance with a SIMD paradigm may perform the functionality described herein. Alternatively, it is contemplated that computing systems that do not perform processing tasks in accordance with a SIMD paradigm performs the functionality described herein.

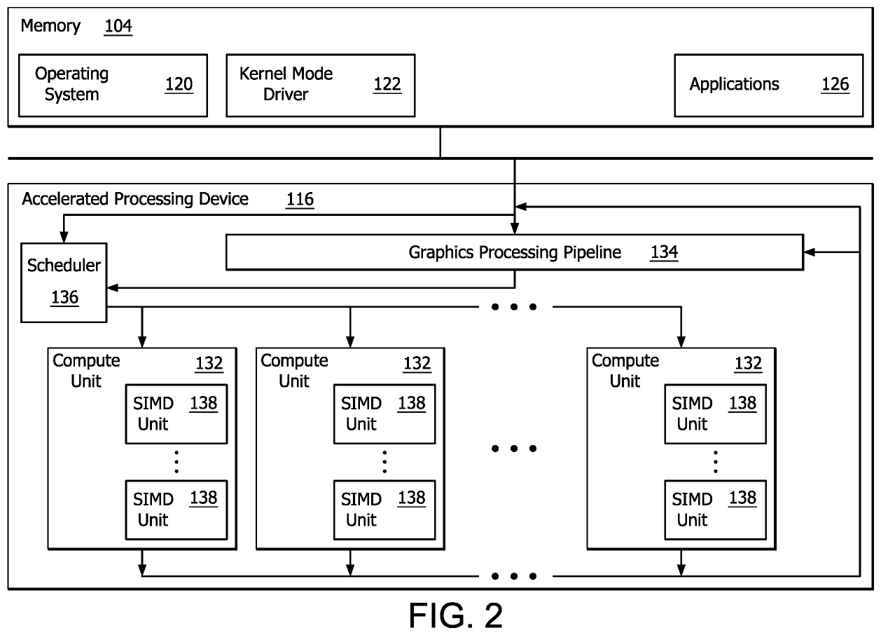

FIG. 2 is a block diagram of the device 100, illustrating additional details related to execution of processing tasks on the APD 116. The processor 102 maintains, in system memory 104, one or more control logic modules for execution by the processor 102. The control logic modules include an operating system 120, a kernel mode driver 122, and applications 126. These control logic modules control various features of the operation of the processor 102 and the APD 116. For example, the operating system 120 directly communicates with hardware and provides an interface to the hardware for other software executing on the processor 102. The kernel mode driver 122 controls operation of the APD 116 by, for example, providing an application programming interface (“API”) to software (e.g., applications 126) executing on the processor 102 to access various functionality of the APD 116. The kernel mode driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that perform operations at the request of the processor 102 in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed sequentially on a single SIMD unit 138 or partially or fully in parallel on different SIMD units 138. Wavefronts can be thought of as the largest collection of work-items that can be executed simultaneously on a single SIMD unit 138. Thus, if commands received from the processor 102 indicate that a particular program is to be parallelized to such a degree that the program cannot execute on a single SIMD unit 138 simultaneously, then that program is broken up into wavefronts which are parallelized on two or more SIMD units 138 or serialized on the same SIMD unit 138 (or both parallelized and serialized as needed). A scheduler 136 performs operations related to scheduling various wavefronts on different compute units 132 and SIMD units 138.

The parallelism afforded by the compute units 132 is suitable for graphics related operations such as pixel value calculations, vertex transformations, and other graphics operations. Thus, in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

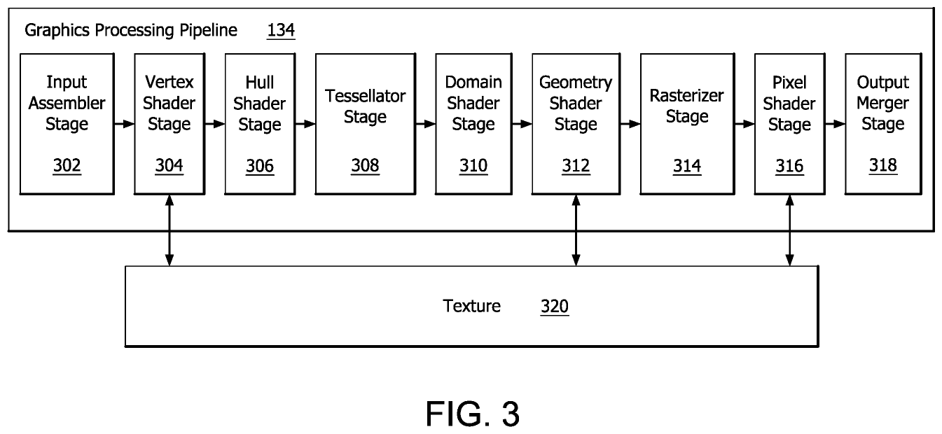

FIG. 3 is a block diagram showing additional details of the graphics processing pipeline 134 illustrated in FIG. 2. The graphics processing pipeline 134 includes stages that each performs specific functionality. The stages represent subdivisions of functionality of the graphics processing pipeline 134. Each stage is implemented partially or fully as shader programs executing in the programmable processing units 202, or partially or fully as fixed-function, non-programmable hardware external to the programmable processing units 202.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertexes of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations. Herein, such transformations are considered to modify the coordinates or “position” of the vertices on which the transforms are performed. Other operations of the vertex shader stage 304 modify attributes other than the coordinates.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the programmable processing units 202.

The geometry shader stage 312 performs vertex operations on a primitive-by-primitive basis. A variety of different types of operations can be performed by the geometry shader stage 312, including operations such as point sprint expansion, dynamic particle system operations, fur-fin generation, shadow volume generation, single pass render-to-cubemap, per-primitive material swapping, and per-primitive material setup. In some instances, a shader program that executes on the programmable processing units 202 perform operations for the geometry shader stage 312.

The rasterizer stage 314 accepts and rasterizes simple primitives and generated upstream. Rasterization includes determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a shader program that executes on the programmable processing units 202.

The output merger stage 318 accepts output from the pixel shader stage 316 and merges those outputs, performing operations such as z-testing and alpha blending to determine the final color for a screen pixel.

Texture data, which defines textures, are stored and/or accessed by the texture unit 320. Textures are bitmap images that are used at various points in the graphics processing pipeline 134. For example, in some instances, the pixel shader stage 316 applies textures to pixels to improve apparent rendering complexity (e.g., to provide a more “photorealistic” look) without increasing the number of vertices to be rendered.

In some instances, the vertex shader stage 304 uses texture data from the texture unit 320 to modify primitives to increase complexity, by, for example, creating or modifying vertices for improved aesthetics. In one example, the vertex shader stage 304 uses a height map stored in the texture unit 320 to modify displacement of vertices. This type of technique can be used, for example, to generate more realistic looking water as compared with textures only being used in the pixel shader stage 316, by modifying the position and number of vertices used to render the water. In some instances, the geometry shader stage 312 accesses texture data from the texture unit 320.

As described and illustrated in FIG. 3, a depiction is provided of the graphics workloads running on a GPU hardware (HW). Additionally, or alternatively, general-purpose computing on graphics processing units (GPGPU), or compute, workloads running on GPU HW may be used. While the HW blocks of GPUs are the same, the meaning of the blocks may be different for GPGPU, as textures, pixels, etc. only make sense for graphics.

GPUs may process independent vertices and fragments, and may process many independent vertices and fragments in parallel. This is especially effective when a programmer wants to process many vertices or fragments in the same way. In this sense, GPUs are stream processors—processors that can operate in parallel by running one kernel on many records in a stream at once.

The discussion referring to vertices, fragments and textures concerns mainly the legacy model of GPGPU programming, where graphics application programming interfaces (APIs), such as open graphics library (OpenGL) or DirectX, may be used to perform general-purpose computation. With the introduction of the compute unit device architecture (CUDA) and open computing language (OpenCL), general-purpose computing APIs, in new GPGPU codes mapping the computation to the graphics primitives may no longer be necessary. The stream processing nature of GPUs remains valid regardless of the APIs used.

The most common form for a stream to take in GPGPU is a 2D grid because this fits naturally with the rendering model built into GPUs. Many computations naturally map into grids: matrix algebra, image processing, physically based simulation, and so on. Since textures are used as memory, texture lookups are then used as memory reads allowing certain operations to be performed automatically by the GPU.

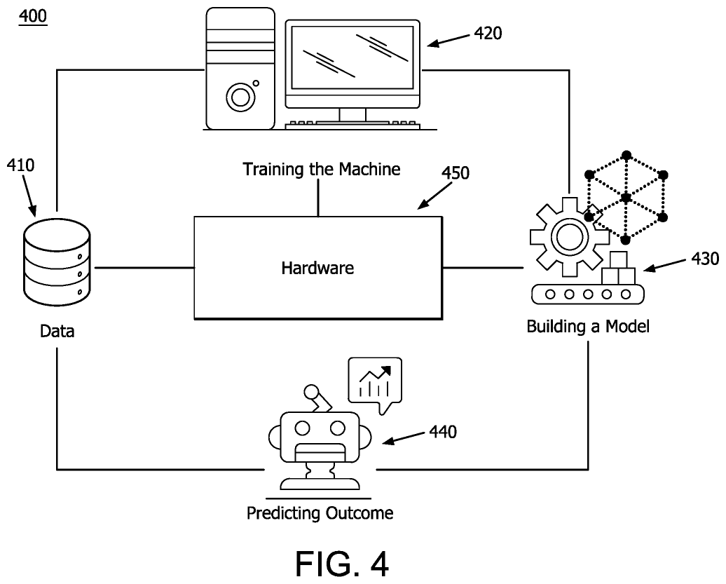

FIG. 4 illustrates a graphical depiction of an artificial intelligence system 200 incorporating the example device of FIG. 1. System 400 includes data 410, a machine 420, a model 430, a plurality of outcomes 440 and underlying hardware 450. System 400 operates by using the data 410 to train the machine 420 while building a model 430 to enable a plurality of outcomes 440 to be predicted. The system 400 may operate with respect to hardware 450. In such a configuration, the data 410 may be related to hardware 450 and may originate with apparatus 102, for example. For example, the data 410 may be on-going data, or output data associated with hardware 450. The machine 420 may operate as the controller or data collection associated with the hardware 450, or be associated therewith. The model 430 may be configured to model the operation of hardware 450 and model the data 410 collected from hardware 450 in order to predict the outcome achieved by hardware 450. Using the outcome 440 that is predicted, hardware 450 may be configured to provide a certain desired outcome 440 from hardware 450.

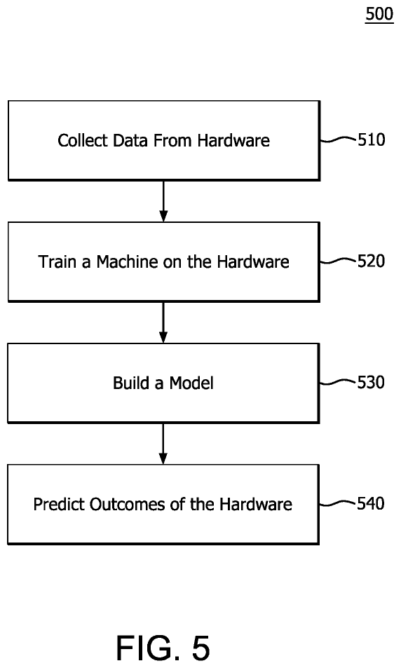

FIG. 5 illustrates a method 500 performed in the artificial intelligence system of FIG. 4. Method 500 includes collecting data from the hardware at step 510. This data may include currently collected, historical or other data from the hardware. For example, this data may include measurements during a surgical procedure and may be associated with the outcome of the procedure. For example, the temperature of a heart may be collected and correlated with the outcome of a heart procedure.

At step 520, method 500 includes training a machine on the hardware. The training may include an analysis and correlation of the data collected in step 510. For example, in the case of the heart, the data of temperature and outcome may be trained to determine if a correlation or link exists between the temperature of the heart during the procedure and the outcome.

At step 530, method 500 includes building a model on the data associated with the hardware. Building a model may include physical hardware or software modeling, algorithmic modeling and the like, as will be described below. This modeling may seek to represent the data that has been collected and trained.

At step 540, method 500 includes predicting the outcomes of the model associated with the hardware. This prediction of the outcome may be based on the trained model. For example, in the case of the heart, if the temperature during the procedure between 97.7-100.2 produces a positive result from the procedure, the outcome can be predicted in a given procedure based on the temperature of the heart during the procedure. While this model is rudimentary, it is provided for exemplary purposes and to increase understanding of the present invention.

The present system and method operate to train the machine, build the model and predict outcomes using algorithms. These algorithms may be used to solve the trained model and predict outcomes associated with the hardware. These algorithms may be divided generally into classification, regression and clustering algorithms.

For example, a classification algorithm is used in the situation where the dependent variable, which is the variable being predicted, is divided into classes and predicting a class, the dependent variable, for a given input. Thus, a classification algorithm is used to predict an outcome, from a set number of fixed, predefined outcomes. A classification algorithm may include naive Bayes algorithms, decision trees, random forest classifiers, logistic regressions, support vector machines and k nearest neighbors.

Generally, a naive Bayes algorithm follows the Bayes theorem, and follows a probabilistic approach. As would be understood, other probabilistic-based algorithms may also be used, and generally operate using similar probabilistic principles to those described below for the exemplary naive Bayes algorithm.

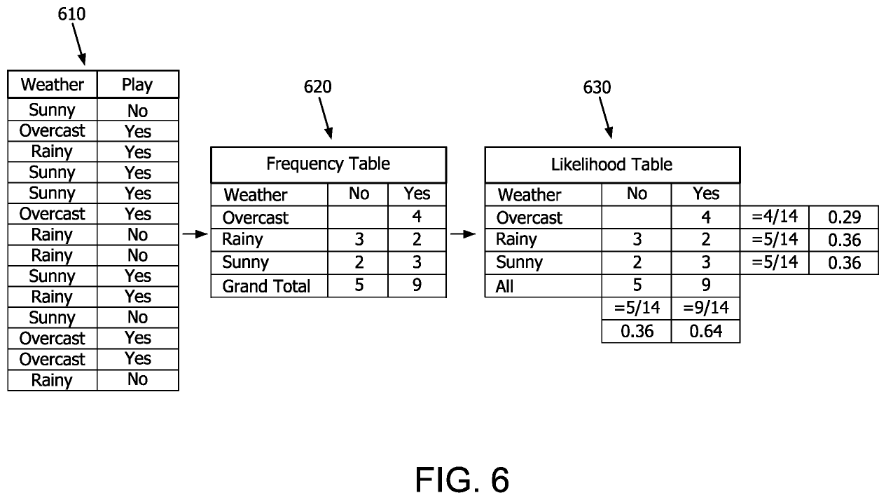

FIG. 6 illustrates an example of the probabilities of a naive Bayes calculation. The probability approach of Bayes theorem essentially means, that instead of jumping straight into the data, the algorithm has a set of prior probabilities for each of the classes for the target. After the data is entered, the naive Bayes algorithm may update the prior probabilities to form a posterior probability. This is given by the formula:

$$posterior = \frac{prior \times likelihood}{evidence}$$

This naive Bayes algorithm, and Bayes algorithms generally, may be useful when needing to predict whether your input belongs to a given list of n classes or not. The probabilistic approach may be used because the probabilities for all the n classes will be quite low.

For example, as illustrated in FIG. 6, a person playing golf, which depends on factors including the weather outside shown in a first data set 610. The first data set 610 illustrates the weather in a first column and an outcome of playing associated with that weather in a second column. In the frequency table 620 the frequencies with which certain events occur are generated. In frequency table 620, the frequency of a person playing or not playing golf in each of the weather conditions is determined. From there, a likelihood table is compiled to generate initial probabilities. For example, the probability of the weather being overcast is 0.29 while the general probability of playing is 0.64.

The posterior probabilities may be generated from the likelihood table 630. These posterior probabilities may be configured to answer questions about weather conditions and whether golf is played in those weather conditions. For example, the probability of it being sunny outside and golf being played may be set forth by the Bayesian formula:

P(Yes|Sunny)=P(Sunny|Yes)*P(Yes)/P(Sunny)

According to likelihood table 630:

P(Sunny|Yes)=3/9=0.33,

P(Sunny)=5/14=0.36,

P(Yes)=9/14=0.64.

Therefore, the P(Yes|Sunny)=0.33*0.64/0.36 or approximately 0.60 (60%).

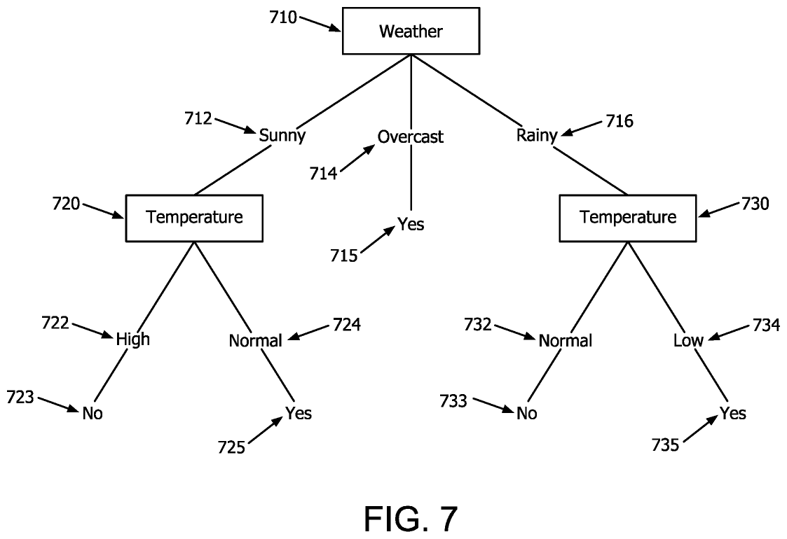

Generally, a decision tree is a flowchart-like tree structure where each external node denotes a test on an attribute and each branch represents the outcome of that test. The leaf nodes contain the actual predicted labels. The decision tree begins from the root of the tree with attribute values being compared until a leaf node is reached. A decision tree can be used as a classifier when handling high dimensional data and when little time has been spent behind data preparation. Decision trees may take the form of a simple decision tree, a linear decision tree, an algebraic decision tree, a deterministic decision tree, a randomized decision tree, a nondeterministic decision tree, and a quantum decision tree. An exemplary decision tree is provided below in FIG. 7.

FIG. 7 illustrates a decision tree, along the same structure as the Bayes example above, in deciding whether to play golf. In the decision tree, the first node 710 examines the weather providing sunny 712, overcast 714, and rain 716 as the choices to progress down the decision tree. If the weather is sunny, the leg of the tree is followed to a second node 720 examining the temperature. The temperature at node 720 may be high 722 or normal 724, in this example. If the temperature at node 720 is high 722, then the predicted outcome of “No” 723 golf occurs. If the temperature at node 720 is normal 724, then the predicted outcome of “Yes” 725 golf occurs.

Further, from the first node 710, an outcome overcast 714, “Yes” 715 golf occurs.

From the first node weather 710, an outcome of rain 716 results in the third node 730 (again) examining temperature. If the temperature at third node 730 is normal 732, then “Yes” 733 golf is played. If the temperature at third node 730 is low 734, then “No” 735 golf is played.

From this decision tree, a golfer plays golf if the weather is overcast 715, in normal temperature sunny weather 725, and in normal temperature rainy weather 733, while the golfer does not play if there are sunny high temperatures 723 or low rainy temperatures 735.

A random forest classifier is a committee of decision trees, where each decision tree has been fed a subset of the attributes of data and predicts on the basis of that subset. The mode of the actual predicted values of the decision trees are considered to provide an ultimate random forest answer. The random forest classifier, generally, alleviates overfitting, which is present in a standalone decision tree, leading to a much more robust and accurate classifier.

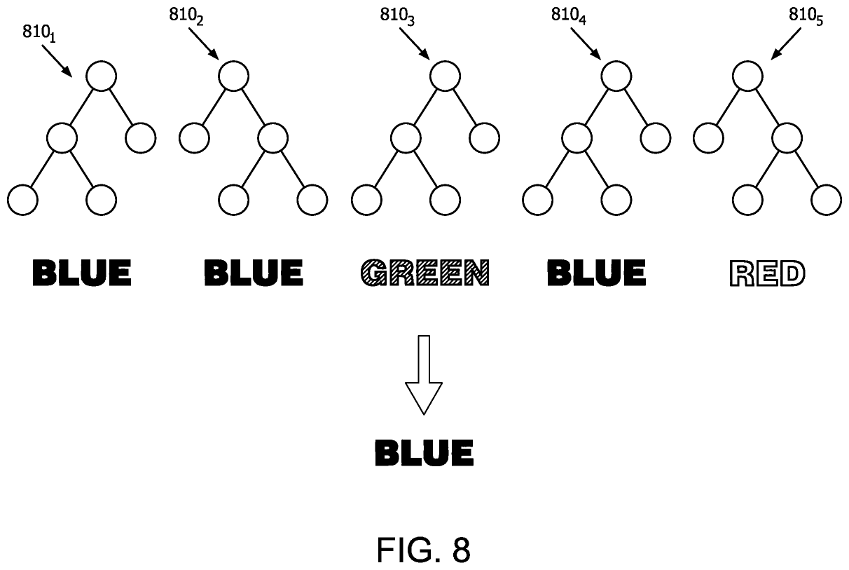

FIG. 8 illustrates an exemplary random forest classifier for classifying the color of a garment. As illustrated in FIG. 8, the random forest classifier includes five decision trees 810₁, 810₂, 810₃, 810₄, and 810₅ (collectively or generally referred to as decision trees 810). Each of the trees is designed to classify the color of the garment. A discussion of each of the trees and decisions made is not provided, as each individual tree generally operates as the decision tree of FIG. 7. In the illustration, three (810₁, 810₂, 810₄) of the five trees determines that the garment is blue, while one determines the garment is green (810₃) and the remaining tree determines the garment is red (810₅). The random forest takes these actual predicted values of the five trees and calculates the mode of the actual predicted values to provide random forest answer that the garment is blue.

Logistic Regression is another algorithm for binary classification tasks. Logistic regression is based on the logistic function, also called the sigmoid function. This S-shaped curve can take any real-valued number and map it between 0 and 1 asymptotically approaching those limits. The logistic model may be used to model the probability of a certain class or event existing such as pass/fail, win/lose, alive/dead or healthy/sick. This can be extended to model several classes of events such as determining whether an image contains a cat, dog, lion, etc. Each object being detected in the image would be assigned a probability between 0 and 1 with the sum of the probabilities adding to one.

In the logistic model, the log-odds (the logarithm of the odds) for the value labeled “1” is a linear combination of one or more independent variables (“predictors”); the independent variables can each be a binary variable (two classes, coded by an indicator variable) or a continuous variable (any real value). The corresponding probability of the value labeled “1” can vary between 0 (certainly the value “0”) and 1 (certainly the value “1”), hence the labeling; the function that converts log-odds to probability is the logistic function, hence the name. The unit of measurement for the log-odds scale is called a logit, from logistic unit, hence the alternative names. Analogous models with a different sigmoid function instead of the logistic function can also be used, such as the probit model; the defining characteristic of the logistic model is that increasing one of the independent variables multiplicatively scales the odds of the given outcome at a constant rate, with each independent variable having its own parameter; for a binary dependent variable this generalizes the odds ratio.

In a binary logistic regression model, the dependent variable has two levels (categorical). Outputs with more than two values are modeled by multinomial logistic regression and, if the multiple categories are ordered, by ordinal logistic regression (for example the proportional odds ordinal logistic model). The logistic regression model itself simply models probability of output in terms of input and does not perform statistical classification (it is not a classifier), though it can be used to make a classifier, for instance by choosing a cutoff value and classifying inputs with probability greater than the cutoff as one class, below the cutoff as the other; this is a common way to make a binary classifier.

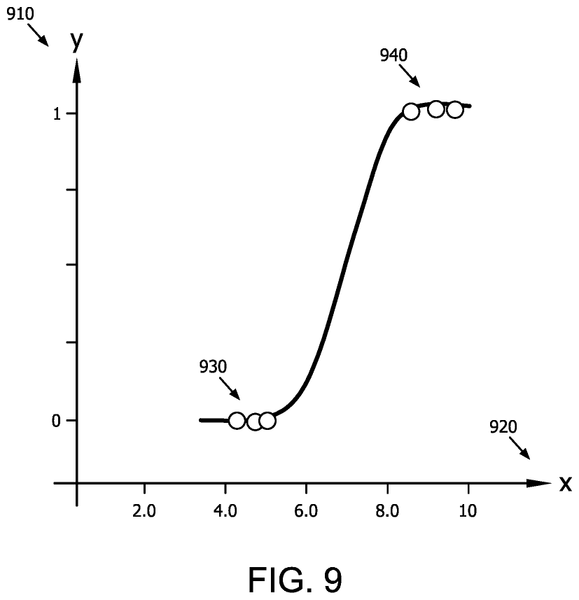

FIG. 9 illustrates an exemplary logistic regression. This exemplary logistic regression enables the prediction of an outcome based on a set of variables. For example, based on a person's grade point average, and outcome of being accepted to a school may be predicted. The past history of grade point averages and the relationship with acceptance enables the prediction to occur. The logistic regression of FIG. 9 enables the analysis of the grade point average variable 920 to predict the outcome 910 defined by 0 to 1. At the low end 930 of the S-shaped curve, the grade point average 920 predicts an outcome 910 of not being accepted. While at the high end 940 of the S-shaped curve, the grade point average 920 predicts an outcome 910 of being accepted. Logistic regression may be used to predict house values, customer lifetime value in the insurance sector, etc.

A support vector machine (SVM) may be used to sort the data with the margins between two classes as far apart as possible. This is called maximum margin separation. The SVM may account for the support vectors while plotting the hyperplane, unlike linear regression which uses the entire dataset for that purpose.

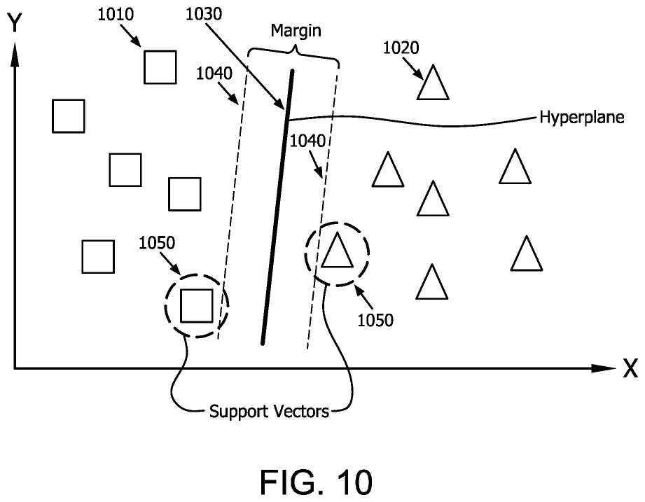

FIG. 10 illustrates an exemplary support vector machine. In the exemplary SVM 1000, data may be classified into two different classes represented as squares 1010 and triangles 1020. SVM 1000 operates by drawing a random hyperplane 1030. This hyperplane 1030 is monitored by comparing the distance (illustrated with lines 1040) between the hyperplane 1030 and the closest data points 1050 from each class. The closest data points 1050 to the hyperplane 1030 are known as support vectors. The hyperplane 1030 is drawn based on these support vectors 1050 and an optimum hyperplane has a maximum distance from each of the support vectors 1050. The distance between the hyperplane 1030 and the support vectors 1050 is known as the margin.

SVM 1000 may be used to classify data by using a hyperplane 1030, such that the distance between the hyperplane 1030 and the support vectors 1050 is maximum. Such an SVM 1000 may be used to predict heart disease, for example.

K Nearest Neighbors (KNN) refers to a set of algorithms that generally do not make assumptions on the underlying data distribution, and perform a reasonably short training phase. Generally, KNN uses many data points separated into several classes to predict the classification of a new sample point. Operationally, KNN specifies an integer N with a new sample. The N entries in the model of the system closest to the new sample are selected. The most common classification of these entries is determined and that classification is assigned to the new sample. KNN generally requires the storage space to increase as the training set increases. This also means that the estimation time increases in proportion to the number of training points.

In regression algorithms, the output is a continuous quantity so regression algorithms may be used in cases where the target variable is a continuous variable. Linear regression is a general example of regression algorithms. Linear regression may be used to gauge genuine qualities (cost of houses, number of calls, all out deals and so forth) in view of the consistent variable(s). A connection between the variables and the outcome is created by fitting the best line (hence linear regression). This best fit line is known as regression line and spoken to by a direct condition Y=a*X+b. Linear regression is best used in approaches involving a low number of dimensions

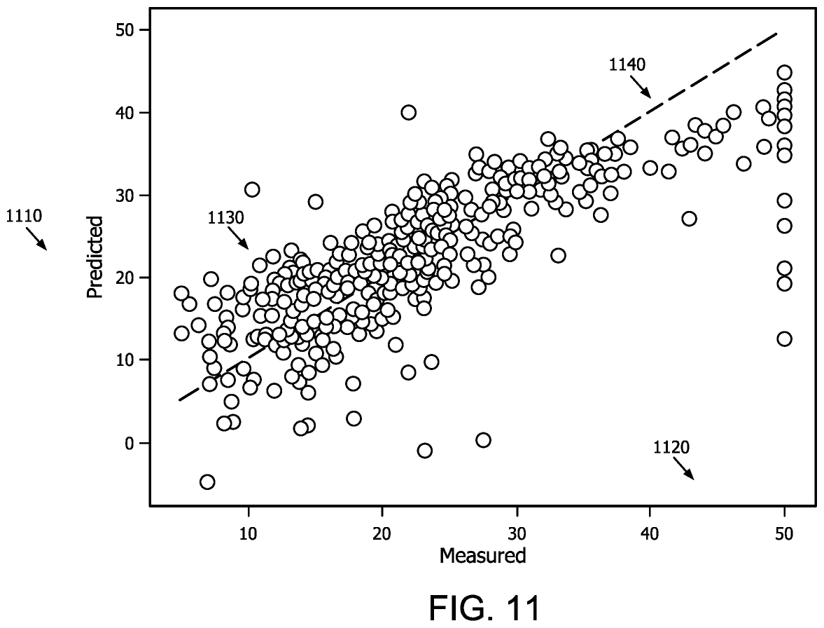

FIG. 11 illustrates an exemplary linear regression model. In this model, a predicted variable 1110 is modeled against a measured variable 1120. A cluster of instances of the predicted variable 1110 and measured variable 1120 are plotted as data points 1130. Data points 1130 are then fit with the best fit line 1140. Then the best fit line 1140 is used in subsequent predicted, given a measured variable 1120, the line 1140 is used to predict the predicted variable 1110 for that instance. Linear regression may be used to model and predict in a financial portfolio, salary forecasting, real estate and in traffic in arriving at estimated time of arrival.

Clustering algorithms may also be used to model and train on a data set. In clustering, the input is assigned into two or more clusters based on feature similarity. Clustering algorithms generally learn the patterns and useful insights from data without any guidance. For example, clustering viewers into similar groups based on their interests, age, geography, etc. may be performed using unsupervised learning algorithms like K-means clustering.

K-means clustering generally is regarded as a simple unsupervised learning approach. In K-means clustering similar data points may be gathered together and bound in the form of a cluster. One method for binding the data points together is by calculating the centroid of the group of data points. In determining effective clusters, in K-means clustering the distance between each point from the centroid of the cluster is evaluated. Depending on the distance between the data point and the centroid, the data is assigned to the closest cluster. The goal of clustering is to determine the intrinsic grouping in a set of unlabeled data. The ‘K’ in K-means stands for the number of clusters formed. The number of clusters (basically the number of classes in which new instances of data may be classified) may be determined by the user. This determination may be performed using feedback and viewing the size of the clusters during training, for example.

K-means is used majorly in cases where the data set has points which are distinct and well separated, otherwise, if the clusters are not separated the modeling may render the clusters inaccurate. Also, K-means may be avoided in cases where the data set contains a high number of outliers or the data set is non-linear.

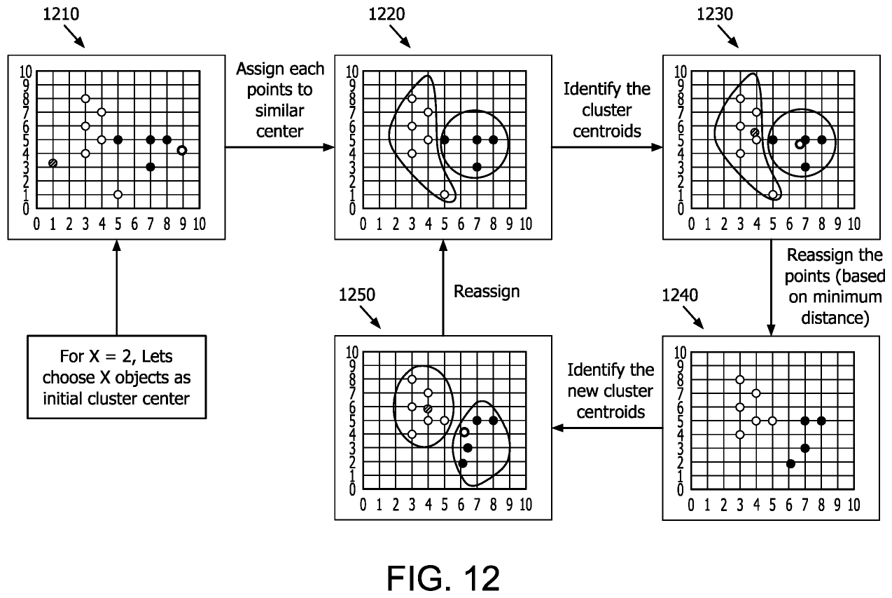

FIG. 12 illustrates a K-means clustering. In K-means clustering, the data points are plotted and the K value is assigned. For example, for K=2 in FIG. 12, the data points are plotted as shown in depiction 1210. The points are then assigned to similar centers at step 1220. The cluster centroids are identified as shown in 1230. Once centroids are identified, the points are reassigned to the cluster to provide the minimum distance between the data point to the respective cluster centroid as illustrated in 1240. Then a new centroid of the cluster may be determined as illustrated in depiction 1250. As the data pints are reassigned to a cluster, new cluster centroids formed, an iteration, or series of iterations, may occur to enable the clusters to be minimized in size and the centroid of the optimal centroid determined. Then as new data points are measured, the new data points may be compared with the centroid and cluster to identify with that cluster.

Ensemble learning algorithms may be used. These algorithms use multiple learning algorithms to obtain better predictive performance than could be obtained from any of the constituent learning algorithms alone. Ensemble learning algorithms perform the task of searching through a hypothesis space to find a suitable hypothesis that will make good predictions with a particular problem. Even if the hypothesis space contains hypotheses that are very well-suited for a particular problem, it may be very difficult to find a good hypothesis. Ensemble algorithms combine multiple hypotheses to form a better hypothesis. The term ensemble is usually reserved for methods that generate multiple hypotheses using the same base learner. The broader term of multiple classifier systems also covers hybridization of hypotheses that are not induced by the same base learner.

Evaluating the prediction of an ensemble typically requires more computation than evaluating the prediction of a single model, so ensembles may be thought of as a way to compensate for poor learning algorithms by performing a lot of extra computation. Fast algorithms such as decision trees are commonly used in ensemble methods, for example, random forests, although slower algorithms can benefit from ensemble techniques as well.

An ensemble is itself a supervised learning algorithm, because it can be trained and then used to make predictions. The trained ensemble, therefore, represents a single hypothesis. This hypothesis, however, is not necessarily contained within the hypothesis space of the models from which it is built. Thus, ensembles can be shown to have more flexibility in the functions they can represent. This flexibility can, in theory, enable them to over-fit the training data more than a single model would, but in practice, some ensemble techniques (especially bagging) tend to reduce problems related to over-fitting of the training data.

Empirically, ensemble algorithms tend to yield better results when there is a significant diversity among the models. Many ensemble methods, therefore, seek to promote diversity among the models they combine. Although non-intuitive, more random algorithms (like random decision trees) can be used to produce a stronger ensemble than very deliberate algorithms (like entropy-reducing decision trees). Using a variety of strong learning algorithms, however, has been shown to be more effective than using techniques that attempt to dumb-down the models in order to promote diversity.

The number of component classifiers of an ensemble has a great impact on the accuracy of prediction. A priori determining of ensemble size and the volume and velocity of big data streams make this even more crucial for online ensemble classifiers. A theoretical framework suggests that there are an ideal number of component classifiers for an ensemble such that having more or less than this number of classifiers would deteriorate the accuracy. The theoretical framework shows that using the same number of independent component classifiers as class labels gives the highest accuracy.

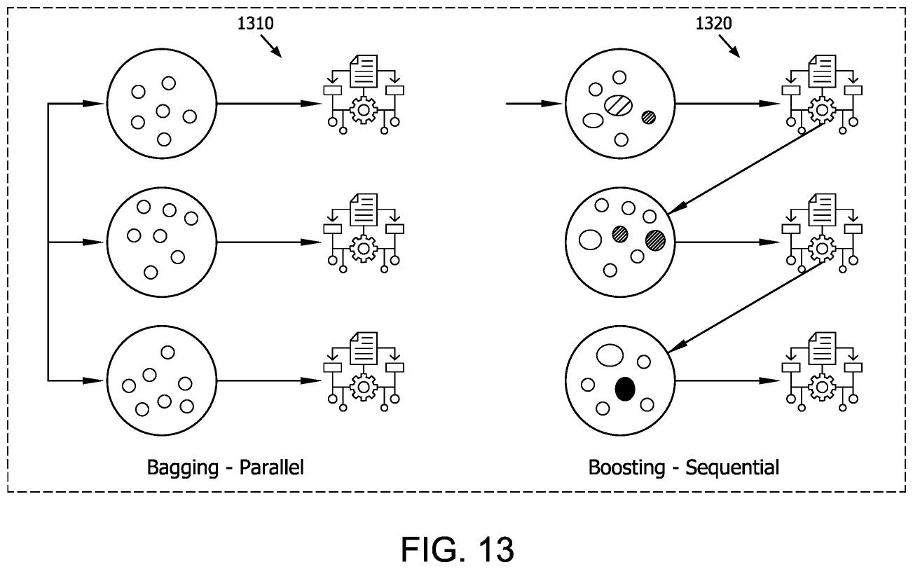

Some common types of ensembles include Bayes optimal classifier, bootstrap aggregating (bagging), boosting, Bayesian model averaging, Bayesian model combination, bucket of models and stacking. FIG. 13 illustrates an exemplary ensemble learning algorithm where bagging is being performed in parallel 1310 and boosting is being performed sequentially 1320.

A neural network is a network or circuit of neurons, or in a modern sense, an artificial neural network, composed of artificial neurons or nodes. The connections of the biological neuron are modeled as weights. A positive weight reflects an excitatory connection, while negative values mean inhibitory connections. Inputs are modified by a weight and summed using a linear combination. An activation function may control the amplitude of the output. For example, an acceptable range of output is usually between 0 and 1, or it could be −1 and 1.

These artificial networks may be used for predictive modeling, adaptive control and applications and can be trained via a dataset. Self-learning resulting from experience can occur within networks, which can derive conclusions from a complex and seemingly unrelated set of information.

For completeness, a biological neural network is composed of a group or groups of chemically connected or functionally associated neurons. A single neuron may be connected to many other neurons and the total number of neurons and connections in a network may be extensive. Connections, called synapses, are usually formed from axons to dendrites, though dendrodendritic synapses and other connections are possible. Apart from the electrical signaling, there are other forms of signaling that arise from neurotransmitter diffusion.

Artificial intelligence, cognitive modeling, and neural networks are information processing paradigms inspired by the way biological neural systems process data. Artificial intelligence and cognitive modeling try to simulate some properties of biological neural networks. In the artificial intelligence field, artificial neural networks have been applied successfully to speech recognition, image analysis and adaptive control, in order to construct software agents (in computer and video games) or autonomous robots.

A neural network (NN), in the case of artificial neurons called artificial neural network (ANN) or simulated neural network (SNN), is an interconnected group of natural or artificial neurons that uses a mathematical or computational model for information processing based on a connectionistic approach to computation. In most cases an ANN is an adaptive system that changes its structure based on external or internal information that flows through the network. In more practical terms neural networks are non-linear statistical data modeling or decision-making tools. They can be used to model complex relationships between inputs and outputs or to find patterns in data.

An artificial neural network involves a network of simple processing elements (artificial neurons) which can exhibit complex global behavior, determined by the connections between the processing elements and element parameters.

One classical type of artificial neural network is the recurrent Hopfield network. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data or task makes the design of such functions by hand impractical.

Neural networks can be used in different fields. The tasks to which artificial neural networks are applied tend to fall within the following broad categories: function approximation, or regression analysis, including time series prediction and modeling; classification, including pattern and sequence recognition, novelty detection and sequential decision making, data processing, including filtering, clustering, blind signal separation and compression.

Application areas of ANNs include nonlinear system identification and control (vehicle control, process control), game-playing and decision making (backgammon, chess, racing), pattern recognition (radar systems, face identification, object recognition), sequence recognition (gesture, speech, handwritten text recognition), medical diagnosis, financial applications, data mining (or knowledge discovery in databases, “KDD”), visualization and e-mail spam filtering. For example, it is possible to create a semantic profile of user's interests emerging from pictures trained for object recognition.

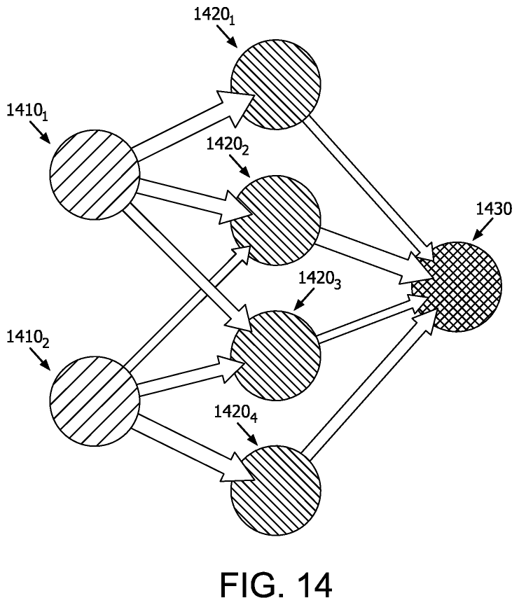

FIG. 14 illustrates an exemplary neural network. In the neural network there is an input layer represented by a plurality of inputs, such as 1410₁ and 1410₂. The inputs 1410₁, 1410₂ are provided to a hidden layer depicted as including nodes 1420₁, 1420₂, 1420₃, 1420₄. These nodes 1420₁, 1420₂, 1420₃, 1420₄ are combined to produce an output 1430 in an output layer. The neural network performs simple processing via the hidden layer of simple processing elements, nodes 1420₁, 1420₂, 1420₃, 1420₄, which can exhibit complex global behavior, determined by the connections between the processing elements and element parameters. The neural network of FIG. 14 may be implemented in hardware.

In selecting from the plurality of algorithms and techniques available, collectively solvers, described above and known in the art, a technique may be needed to ensure improvement by assigning a solver to solve a task. This solver selection needs to account for many practical and diverse problems requiring solutions and solvers with differing performances across problems. That is, while one solver performs well on some tasks, that solver performs poorly on other tasks, and vice versa for another solver. For example, by selecting the well-performing solver in each instance overall performance of the system may be improved.

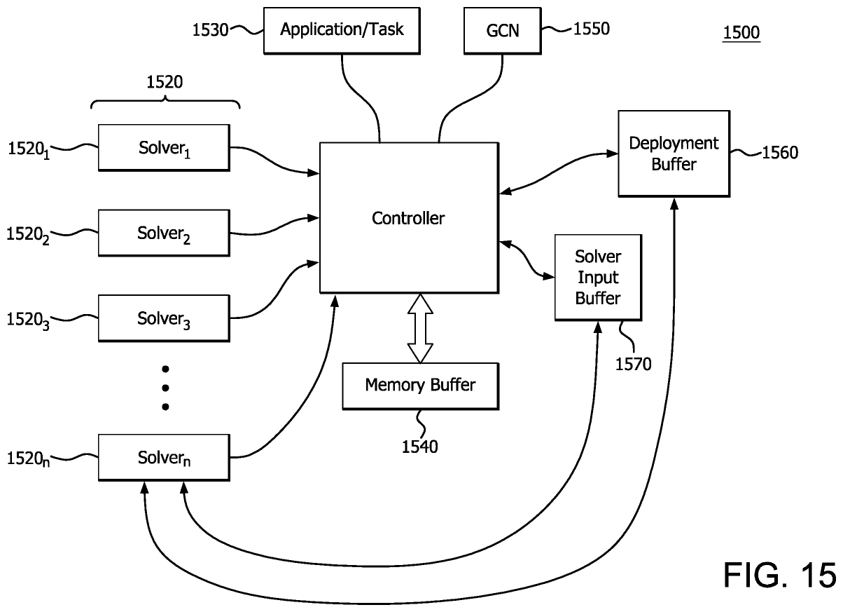

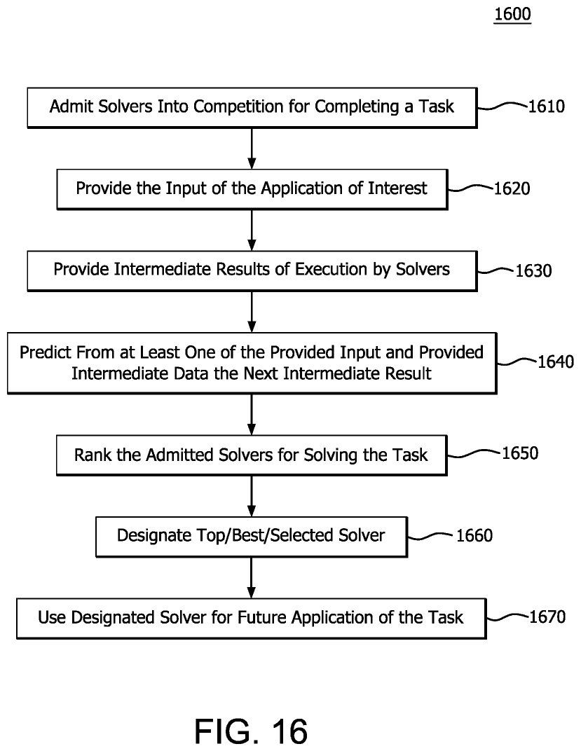

FIG. 15 illustrates a hardware diagram of a system 1500 to provide a hardware assisted tournament for AI adoption. System 1500 provides a hardware, and in conjunction with the method of FIG. 16, allows solvers to be used for tasks to improve the overall performance of the system. System 1500 includes a controller 1510. Controller 1510 may be a tournament controller, for example. Controller 1510 may be communicatively connected to a plurality of solvers 1520. Plurality of solvers 1520 may include any number of solvers, illustrated for simplicity as solver₁ 1520₁, solver₂ 1520₂, solver₃ 1520₃, . . . , solverₙ 1520ₙ. Ones of the plurality of solvers 1520 may be any of the solvers illustrated above in FIGS. 6-14 including probabilities of a naive Bayes calculation, a decision tree, a random forest classifier, a logistic regression, a support vector machine, a linear regression model, a K-means clustering, an ensemble learning algorithm, and a neural network. As would be understood other solvers and algorithms may also be utilized as a solver within the plurality of solvers 1520. A solver within the plurality of solvers 1520 may even include specific solutions to problems presented in specific industries. The plurality of solvers 1520 may be utilized to perform an application or task 1530. The data from the task 1530 may be controlled by controller 1510, which may store the data in a memory buffer 1540. The controller 1510 may provide the data to the plurality of solvers 1520. The task 1530 may be a prediction or process that is to be performed on the data. For example, if the data is a training that is a pre-classified set of images, the task 1530 could be classifying the set of images, i.e., if an image is of a cat, task 1530 may be performed according to a one or more of the plurality of solver's 1520 methodology. The one of the plurality of solvers 1520 that is the best for the task 1530 becomes the incumbent, or the one designated to be used for the task 1530. For example, the best solver for the task is the solver of the plurality of solvers 1520 that classifies the closest to the correct classification.

In an embodiment, controller 1510 may receive the data from a deployment operation via a deployment buffer 1560, which may be a memory-mapped buffer. The deployment buffer 1560 may be configured to include the data designed to be provided to the solvers 1520. Additionally, deployment buffer 1560 may be provided a score script that defines how to calculate the score in determining the best solver for the prediction of the task 1530. Such a score script may be executed in the controller 1510 for every prediction generated by a solver 1520. Deployment buffer 1560 is illustrated as being separate from controller 1510. As would be understood by those possessing ordinary skill in the pertinent art, deployment buffer 1560 may be located within the controller 1510, even though it is depicted as a separate element in FIG. 15.

For example, if the data is a training data set, such as a pre-classified data set of images, the task is classifying those images, again i.e., if an image is a cat, according to a given solver's method. The script supplied by the deployment operator may be a piece of code that counts the number of images from the dataset that include a cat via the solver and compares this value with the true number of cat images, which may be known ahead of time, for example. The best solver may be the one whose prediction diverges the least from the true number.

The controller 1510 may determine to admit ones of the plurality of solvers 1520 into the system 1500. To be admitted into the tournament, ones of the plurality of solvers 1520 may need to adhere the tournament's “rules”. The rules are configured upfront by an administrator or a deployment provider. Such rules may include supplying the compute kernel(s) of the respective solver of the plurality of solvers 1520, reading task data, and generating results of the prediction for that solver.

Ones of the plurality of solvers 1520 may supply the compute kernel(s) of the solver to be executed on the CPU, GPU, or TPU HW, as illustrated in FIGS. 1-3. The kernel may be managed by controller 1510. The one of the plurality of solvers 1520 may copy the kernel, such as manually or via automated scripts, into a memory-mapped buffer, such as solver input buffer 1570 provided by the controller 1510. The one of the plurality of solvers 1520 reads the task 1530 data, e.g., the set of images in the example. Solver input buffer 1570, which may in some embodiments be a Read-Only buffer (ROB), is provided by controller 1510. Controller 1510 populates this solver input buffer 1570 with task data that is supplied separately by the deployment operator (via a writable buffer with a known address). In certain embodiments, ROB start address and ROB size are configurable parameters provided to the solver developers ahead of time via a read-only register. The one of the plurality of solvers 1520 generates the prediction results in performing the task, periodically every N sec, where N is a configurable parameter provided to the solver developers ahead of time via deployment buffer 1560. Solver input buffer 1570 is illustrated as being separate from controller 1510. As would be understood by those possessing ordinary skill in the pertinent art, solver input buffer 1570 may be located within the controller 1510, even though it is depicted as a separate element in FIG. 15.

The admitted ones of the plurality of solvers 1520 (also referred to as contenders) may be provided kernels, such as CPU/GPU/TPU kernels, for example, to solve the task 1530 by generating an output to be compared with the current solver, which may be one of the plurality of solvers 1520. The controller 1510 may create a copy of the binary and kernel files of the current solver and store the copy of the binary and kernel files in the secured memory buffer 1540 for tracking. In an embodiment, the memory buffer 1540 may be located in a trusted execution environment. According to an embodiment, the execution environment may be as described in FIGS. 1-3. Further, the execution environment may include in an ARM Cortex-A5 secure processor or by using Secure Memory Encryption (SME). Generally, the execution environment may include an encrypted memory buffer.

The controller 1510 may accept different types of solvers, including domain-specific (e.g., Monte Carlo, Particle Methods, Sparse Solvers), traditional machine learning (ML) (Markov, Decision trees, SVM, etc.), and AI (e.g., Convolutional, LSTM Neural Networks) solvers, some of which are described herein. Controller 1510 may provide for the admitted solvers to track concurrently in order to be able to monitor the progress of the solvers, for example.

As described, the controller 1510 provides the input of the application or task 1530, such as using invocation files, for example. The one of the plurality of solvers 1520 may copy the kernel, such as manually or via automated scripts, into a special memory-mapped input buffer provided by the controller 1510. The one of the plurality of solvers 1520 reads the task 1530 data, e.g., the set of images, from a solver input buffer 1560 provided by controller 1510. The controller 1510 may provide intermediate results of execution by other admitted solvers, such as at a timed checkpoint, for example, to the admitted solvers.

By way of example, controller 1510 may periodically supply the data to the admitted solvers of the plurality of solvers 1520 via the solver input buffer 1570 and periodically read solvers' predictions from a prediction buffer 1580 If an admitted solver does not generate the prediction in time for the controller 1510 to read the prediction, controller 1510 may ignore the non-predicting solver for the current N sec interval.

In an alternative embodiment, the controller 1510 may include a generative convolutional network (GCN) 1550. GCN 1550 may be designed to mimic the real input data and the intermediate results. The capability of the GCN 1550 to circumvent the need for real data may be beneficial to applications and tasks 1530 that do not process large volumes of data. For example, in training AI methods (like Neural Network) to solve the task 1530, training on additional data is beneficial and may provide convergence for the solver. Utilizing a GCN 1550, or other synthetic data generators, the data disadvantage may be overcome in evaluating the plurality of solvers 1520 in AI adoption. For instance, GANs may be used to produce samples of photorealistic images for the purposes of visualizing new interior/industrial design, shoes, bags and clothing items or items for computer game scenes.

The admitted solvers of the plurality of solvers 1520 use the input and intermediate data provided by controller 1510 to predict the next intermediate result. This next intermediate result may be provided by the solver to the controller 1510. The next intermediate result may be provided as a checkpoint in the processing of the task, for example. The one of the plurality of solvers 1520 generates the prediction results periodically every N sec, where N is a configurable parameter provided to the solver developers ahead of time via deployment buffer 1560.

The controller 1510 may rank each admitted solver of the plurality of solvers 1520. The controller 1510 may be provided with any number of methodologies for ranking the plurality of solvers 1520, and as would be understood, one, two, or a combined multiple different ranking may be used with even weighting or weighted configurations used to combine the rankings. For example, a mode may be set via a register exposed to software or firmware. The specific methodology to provide the ranking may be identified by the deployer of the tournament. This ranking may evaluate the closeness to the incumbent solver and potential benefit to the workload, such as the reduced time or lower power consumption to reach a similar conclusion as the incumbent, for example. The similarity with the incumbent results may be detected via a clustering method or creating a fingerprint by hashing the result. For example, hashing may provide the same fingerprint for similar data, such as Probabilistic Fast File Fingerprinting used in the biological data acquisition. The fingerprint may then be matched with the fingerprints of the incumbent solver, by way of example.

The controller 1510 may periodically designate the top-ranking solver of the plurality of solvers 1520 as a new incumbent, and use the designated solver to solve the task in the future. The periodicity may be controlled using the N parameter set forth above and defined by the deployment via the deployment buffer 1560 memory-mapped register.

While buffers 1560, 1570 are identified as being separate elements, each of these buffers may be memory mapped within controller 1510. For understanding, each of these buffers is described as being a unique buffer, but as would be understood to those possessing any ordinary skill in the art, discrete elements are not necessary. By design, it may be beneficial for the scoring information not to be passed to the solvers involved in the competition, for example. The buffers may have discrete access, at least in part, to prevent unwanted access to passed information, as desired.

FIG. 16 illustrates a method 1600 performed in the hardware of FIG. 15 for providing a hardware assisted tournament for AI adoption. Method 1600 identifies an efficient way of solving a given task by gradual adoption of a new solver. Method 1600 includes, at step 1610, admitting solvers into the competition system. This admission, in step 1610, may be performed within a controller, such as a tournament controller. The admitted solvers may be provided computational accelerator kernels (e.g., for CPU, GPU, or tensor processing unit (TPU)) to solve a given task by generating the output similar to the incumbent solver. The admitted solvers may be selected from different types of solvers, including domain-specific (e.g., Monte Carlo, Particle Methods, Sparse Solvers), the traditional machine learning (ML) (Markov, Decision trees, SVM, etc.), and AI (e.g., Convolutional, LSTM Neural Networks).

At step 1620, method 1600 includes providing the input of the application of interest. The input may be provided via the controller, which creates a copy of the solver's binary and kernel files and stores it in a secured memory buffer for tracking.

At step 1630, method 1600 includes providing the admitted solvers the input of the application of interest via the invocation files and intermediate results of execution by other solvers via time checkpoints. Step 1630 may be performed via the controller, or under the guidance of the controller. In an alternative embodiment, a GCN may mimic the real input data and the intermediate results of the incumbent.

At step 1640, method 1600 includes predicting the next intermediate result (next checkpointing snapshot) for each of the admitted solvers according to their respective techniques using the input and intermediate data of step 1630.

At step 1650, method 1600 includes ranking the admitted solvers for solving the task. In one embodiment, each solver may be ranked with respect to the closeness to the incumbent solver while accounting for the potential benefit to the workload. The workload benefit may be measured via the reduced time or lower power consumption to reach a similar conclusion as compared to the incumbent. As described above, the similarity with the incumbent results can be detected via a clustering method or creating a fingerprint by hashing the result. The ranking may be made by measuring performance (via accuracy of prediction), and/or the compute/memory/power demands of each solver. The different measurements may guide ranking independently or via a weighted sum using some or all of the variables.

At step 1660, method 1600 includes designating the top, best, or selected solver, as defined by the ranking, as the new incumbent for performing the task. This designation may be performed in the controller. At step 1670, method 1600 includes using the new designated solver to solve the task.

By way of example, the image classification described herein throughout may be performed by many solvers, including Convolutional Neural Networks, Decision Trees, SVM, Clustering with K-Nearest Neighbors, etc.

It should be understood that many variations are possible based on the disclosure herein. Although features and elements are described above in particular combinations, each feature or element can be used alone without the other features and elements or in various combinations with or without other features and elements.

The various functional units illustrated in the figures and/or described herein (including, but not limited to, the processor 102, the input driver 112, the input devices 108, the output driver 114, the output devices 110, the accelerated processing device 116, the scheduler 136, the graphics processing pipeline 134, the compute units 132, the SIMD units 138, and the controller 1510) may be implemented as a general purpose computer, a processor, or a processor core, or as a program, software, or firmware, stored in a non-transitory computer readable medium or in another medium, executable by a general purpose computer, a processor, or a processor core. The methods provided can be implemented in a general-purpose computer, a processor, or a processor core. Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements features of the disclosure.

The methods or flow charts provided herein can be implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system for providing a hardware assisted tournament for adoption of one of a plurality of solvers for solving at least one task, the system comprising:
a controller including at least one processor;
a plurality of solvers capable of solving the at least one task; and
at least one memory,
the controller via the at least one processor being configured to:
admit ones of the plurality of solvers into a competition for solving the at least one task;
provide, via the at least one memory, an input of the at least one task to at least one of the admitted ones of the plurality of solvers;
provide, via the at least one memory, intermediate results of execution by the at least one of the admitted ones of the plurality of solvers that are provided the input;
receive a prediction of the next intermediate result from the at least one of the admitted ones of the plurality of solvers predicting from at least one of the provided input and received intermediate results; and
rank the at least one of the admitted ones of the plurality of solvers for solving the task based on at least one of the next intermediate results, the provided input and received intermediate results.

2. The system of claim 1 wherein the plurality of solvers includes at least one domain-specific solver.

3. The system of claim 2 wherein the at least one domain-specific solver includes at least one of a Monte Carlo, Particle Methods, and Sparse Solver.

4. The system of claim 1 wherein the plurality of solvers includes at least one traditional machine learning (ML) solver.

5. The system of claim 4 wherein the at least one ML solver includes at least one of a Markov, Decision trees, and SVM solver.

6. The system of claim 1 wherein the plurality of solvers includes at least one artificial intelligence (AI) solver.

7. The system of claim 6 wherein the at least one AI solver includes at least one of a Convolutional and LSTM Neural Networks solver.

8. The system of claim 1 wherein the controller designates a selected solver based on the ranking of the at least one of the admitted ones of the plurality of solvers.

9. The system of claim 8 wherein the controller uses the designated solver for future processing of the task.

10. The system of claim 1 operating in an execution environment including an encrypted memory buffer.

11. A method providing hardware assisted tournament for adoption of one of a plurality of solvers for solving at least one task, the method comprising:
admitting ones of the plurality of solvers into a competition for solving the at least one a task;
providing an input of the at least one task to at least one of the admitted ones of the plurality of solvers;
providing intermediate results of execution by the at least one of the admitted ones of the plurality of solvers that are provided the input;
receiving a prediction of the next intermediate result from the at least one of the admitted ones of the plurality of solvers predicting from at least one of the provided input and received intermediate results;
ranking the at least one of the admitted ones of the plurality of solvers for solving the task based on at least one of the next intermediate results, the provided input and received intermediate results.

12. The method of claim 11 further comprising designating a selected solver based on the ranking of the at least one of the admitted ones of the plurality of solvers.

13. The method of claim 12 further comprising using the designated solver for future processing of the task.

14. The method of claim 11 wherein the plurality of solvers includes at least one solver selected from at least one domain-specific solver, at least one traditional machine learning (ML) solver, and at least one artificial intelligence (AI) solver.

15. The method of claim 14 wherein the at least one domain-specific solver includes at least one of a Monte Carlo, Particle Methods, and Sparse Solver.

16. The method of claim 14 wherein the at least one ML solver includes at least one of a Markov, Decision trees, and SVM solver.

17. The method of claim 14 wherein the at least one AI solver includes at least one of a Convolutional and LSTM Neural Networks solver.

18. A non-transient computer readable medium including code stored thereon which when executed by a processor cause the system to perform a method for providing a hardware assisted tournament for adoption of one of a plurality of solvers for solving at least one task, the method comprising:
admitting ones of the plurality of solvers into a competition for solving the at least one a task;
providing an input of the at least one task to at least one of the admitted ones of the plurality of solvers;
providing intermediate results of execution by the at least one of the admitted ones of the plurality of solvers that are provided the input;
receiving a prediction of the next intermediate result from the at least one of the admitted ones of the plurality of solvers predicting from at least one of the provided input and received intermediate results;
ranking the at least one of the admitted ones of the plurality of solvers for solving the task based on at least one of the next intermediate results, the provided input and received intermediate results.

19. The computer readable medium of claim 18 further comprising designating a selected solver based on the ranking of the at least one of the admitted ones of the plurality of solvers.

20. The computer readable medium of claim 18 wherein the plurality of solvers includes at least one solver selected from at least one domain-specific solver, at least one traditional machine learning (ML) solver, and at least one artificial intelligence (AI) solver.
